(19) United States
(12) Patent Application Publication
(10) Pub. No.: US 2006/0012492 A1
(43) Pub. Date: Jan. 19, 2006

(54) Holding Pattern Entry Template

(76) Inventor: Joseph Todd Degidio, Houston, TX (US)

Correspondence Address: JOSEPH TODD DEGIDIO, 8402 LARSON, HOUSTON, TX, 77061, US

(21) Appl. No.: 10/710,500

(22) Filed: Jul. 15, 2004

(51) Int. Cl. G01C 23/00

(52) U.S. Cl. 340/971

(57) ABSTRACT

A holding pattern entry template employing a clear circular disc having pertinent graphics and data printed on its face. The crucial graphics are a red in-bound course line and arrow, a blue holding fix triangle in the center of the disc, a red hold pattern depiction, and a blue quadrant line. The data printed on the disc provides the solution to the type holding pattern entry. Three data symbols located in the four quadrants, indicate what entry type will be made based on aircraft path interpretation.

### BRIEF DESCRIPTION OF DRAWINGS

FIG. 1 is a top view of the device of the present invention. FIG. 1 is the first image in the document

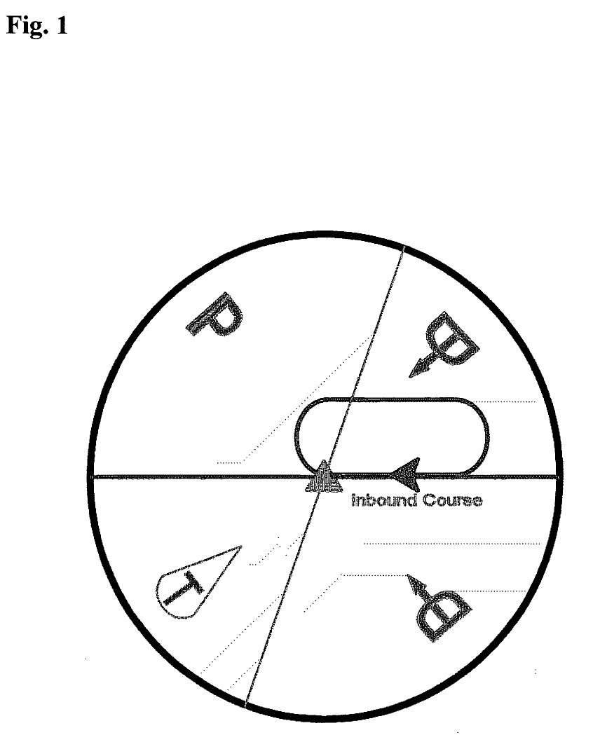

FIG. 2 is a view of the device that includes the hold entry interpretation of the symbols of the template. FIG.2 is the second image in the document.

### DETAILED DESCRIPTION

BACKGROUND OF THE INVENTION [ ]The present invention relates to the field of instrument flying, and more precisely is concerned with readily and efficiently identifying the safe and proper entry method into holding patterns.

During any part of an FAA Instrument Flight Rules (IFR) flight a pilot is subject to receiving a clearance from Air Traffic Control (ATC) to enter a Holding Pattern. Holding Patterns are used to keep aircraft separated from each other for a variety of safety reasons. Once receiving a holding pattern clearance from ATC, the pilot must enter the holding pattern using one of three approved methods. Direct entry, Parallel entry, and Teardrop entry are the three approved methods by which a pilot must enter a holding pattern. Determining which entry to make while in an IFR environment can not only be confusing, it can also be very dangerous depending on the method that is used to determine the entry. Student pilots and experienced pilots, who do not fly IFR on a regular basis, either have limited proficiency or rapidly lose proficiency in determining proper hold entries. This lack of proficiency and/or use of more complex calculation methods of entering holding patterns are precisely why this simple yet highly effective device is needed for safely and properly determining hold entries. The present invention is used in conjunction with any aircraft's standard heading indicator to quickly give a pilot the proper hold entry.

### SUMMARY OF THE INVENTION

In accordance with the present invention; a Holding Pattern Entry Template is described and the method of its use is provided.

The holding pattern entry template of the present invention is composed of a clear Lexan or similar type material that is cut in the shape of a circle, matching the size of a standard aircraft heading indicator. A blue colored triangle shape, which represents a holding fix, is printed in the center of the circle. A red colored line, which represents the in-bound course line of a holding pattern, is printed across the diameter of the circle, through the blue fix triangle. The red in-bound course line contains a red in-bound course arrow, which points to the blue fix triangle. A red oval holding pattern depiction is printed on the in-bound course line, through the blue holding fix triangle, then away from the in-bound course line, back to the in-bound course line, and back to the blue fix triangle. A blue quadrant line running the diameter of the circle is printed through the blue fix triangle. This blue quadrant line is printed with a 70-degree angle to the red in-bound course line, on the same side, in relation to the blue triangle, that the red holding pattern oval is located. The 110-degree angle of the blue quadrant line must be on the opposite side of the 70-degree angle, and on the side of the in-bound course line, in relation to the blue triangle, that the majority of the holding pattern oval is not located. Four symbols are printed in the four quadrants that are made up from the red in-bound course line and the blue Quadrant line. These symbols depict the three different types of hold entries. Two of the quadrants have the same direct entry symbol.

The holding pattern entry template has a means for positioning the blue holding fix triangle over the center of an aircraft's heading indicator, so that the blue triangle is viewed over the airplane depiction on the heading indicator. There is further means to align the red in-bound course line so that the arrow points to the holding pattern's in-bound course on the heading indicator. The in-bound course is obtained from interpretation of the ATC hold clearance.

The holding pattern entry template has further means to allow the invention to be flipped and/or rotated over the heading indicator in order to view the holding pattern in the proper relationship to the cardinal headings and the proper turns of the holding pattern. All holding patterns are either left or right hand turns. The clearance that is obtained from ATC will determine the aforementioned holding pattern characteristics. The pilot would simply place the holding pattern entry template over the heading indicator in the proper relationships to view a correct holding pattern.

The method for determining the hold entry is to view the airplane depiction on the heading indicator, through the holding pattern entry template, which is held in the proper relationship over the heading indicator. From the tail or rear of the airplane depiction, the pilot must imagine a path that the airplane would have just followed and determine which quadrant the airplane would have come from.

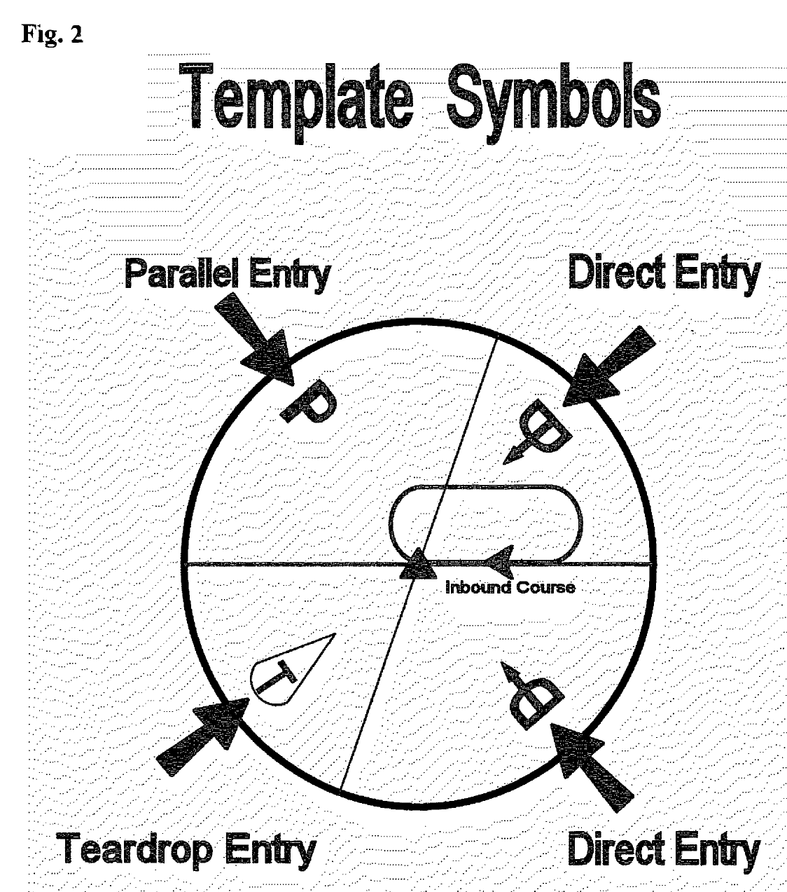

Finally, the symbol located in the corresponding quadrant will be the correct and safe hold entry technique as prescribed by the FAA. The symbols of the three types of hold entries may be viewed from FIG. 2.

It may be apparent that a novel and simple holding pattern entry template has been described heretofore.

It is therefore the object of the present invention to provide a holding pattern entry template usable while in flight when a determination must be made in regards to a hold entry.

It is another object of the present invention to provide a holding pattern entry template that serves as a visual representation of the entire holding pattern in relation to the cardinal directions of the heading indicator.

It is another object of the present invention to provide a holding pattern entry template that allows the continuation of the visual scan of the instrumentation panel of an aircraft, while the hold entry is calculated.

It is yet another object of the present invention to provide a holding pattern entry template that is portable and is operated manually.

It is still another object of the present invention to provide a holding pattern entry template, which serves as a teaching aid for novice pilots.

The invention possesses other objects and advantages especially as to concerns particular features and characteristics thereof, which will become apparent as the specification continues.

Having thus described the invention, what is claimed is:

1. A device that is an aircraft navigational aid used for determining the safe and proper entry to be made into a holding pattern, comprising of a clear round disc with printed holding pattern data and solution symbols.

2. The device according to claim 1, wherein the means to obtain a proper hold entry will be to align the in-bound course of a holding pattern with the respective bearing on an aircraft's heading indicator and position the device over the aircraft's heading indicator in the proper orientation based on the ATC hold instructions.

3. The device according to claim 2, wherein the means to continue a safe and efficient scan of the cockpit instrumentation panel necessary for an IFR flight environment, achieved by the proximity device, while in use, to the required scan instrumentation, and the clear material used in the construction, which enables view through and to the heading indicator.

4. The device according to claim 2, where in the means to view a proper holding pattern in relation to the cardinal directions and aircrafts heading by viewing the template over the aircraft's heading indicator.
